(19) United States
(12) Patent Application Publication
(10) Pub. No.: US 2014/0148140 A1
(43) Pub. Date: May 29, 2014

(54) POLICY-BASED MOBILE DEVICE MANAGEMENT SYSTEM (MDMS) BASED ON ACCESS HISTORY INFORMATION

(71) Applicant: LG CNS CO., LTD., Seoul (KR)

(72) Inventors: Byung Hyun Ahn, Seoul (KR); Ja Yoon Kong, Seoul (KR); Yong Seock Pai, Seoul (KR); Gwang Sik Suh, Seoul (KR); Sunhaw Shim, Seoul (KR); Manho Han, Seoul (KR)

(73) Assignee: LG CNS CO., LTD., Seoul (KR)

(21) Appl. No.: 13/689,048

(22) Filed: Nov. 29, 2012

(51) Int. Cl. H04W 4/02

(52) U.S. Cl. CPC H04W 4/028
USPC 455/418

(57) ABSTRACT

Embodiments of the invention described herein provide approaches relating generally to location position management of mobile devices. Specifically, a policy-based mobile device management system (MDMS) is provided for determining a location of a mobile device based on the user's access history information and controlling the mobile device based on the location.

### BACKGROUND

1. Technical Field

The present invention relates generally to location position management of a mobile device and, more particularly, to a policy-based mobile device management system (MDMS) for determining a location of a mobile device based on the user's access history information and controlling the mobile device based on the location.

2. Related Art

Nowadays, wireless communication devices are equipped with various enhanced features to identify their current geographical location. Examples of wireless communication devices include mobile devices such as cell phones, laptops, and personal digital assistants (PDA). Many wireless communication devices (e.g., mobile devices), are equipped with global positioning system (GPS) navigators to identify their current location. Hence, a mobile device in the wireless communication network, upon receiving a request to find its coordinates or current geographical location, automatically switches on the GPS module for resolving geographical bearings.

Another method to identify a current location is the use of the Wi-Fi triangulation method and Bluetooth triangulation method. In this method, the location of a particular Wi-Fi base station to which the mobile device is currently associated is identified. However, one challenge lies in clearly identifying the physical location of the mobile device, whether the physical location is indoors or outdoors of a building. Also, several additional problems in current geo-location technologies exist. The power consumption at a GPS receiver is always one of the major concerns in view of the portability of the mobile unit. The more data processed at the receiver, the more profound the problem. Having a GPS receiver receive plural signals and then calculate its position requires extensive processing power.

U.S. Pat. No. 7,532,158 describes a system and method for locating mobile devices using location information received from a mobile device to be located, wherein the information may include GPS-related information and/or path length information with respect to one or more signals transmitted by network elements.

U.S. Pat. No. 7,599,796 describes a dual mode location positioning system that comprises multiple wireless or wired network communication devices, one of the multiple network communication devices including a GPS receiver.

United States Patent Application US20110312337 describes a method for identifying location of a mobile device in a wireless communication network that includes identifying Hierarchical Cell Structure (HCS) priority number of a cell in which the mobile device is currently located.

United States Patent Application US20080231499 describes providing a mobile phone device that includes a global positioning system (GPS) module that allows the mobile phone device to be located by a third party device using a location query methodology.

U.S. Pat. No. 6,204,808 discloses a system that receives assistance information developed from ephemeris data via a wireless network to determine the location of a mobile station.

Therefore, what is needed is a solution that is more accurate and energy efficient than the current art.

### SUMMARY

Embodiments of the present invention generally relate to location position management of a mobile device and, more particularly, to a policy-based mobile device management system (MDMS) for determining a location of a mobile device based on the user's access history information and controlling the mobile device based on the location.

One aspect of the present invention includes a method for managing a mobile device in a mobile device management system (MDMS), comprising: receiving control area access information, wherein the control area access information is associated with an entry or exit of a control area location by a mobile device user; determining a policy associated with the control area location; and applying the policy to the mobile device.

Another aspect of the present invention provides mobile device management system for managing a mobile device, comprising: a mobile device configured to communicate with a server; the server configured to store control area access information, wherein the control area access information is associated with an entry or exit of a control area location by a mobile device user; the mobile device further configured to receive the control area access information from the server; the mobile device further configured to determine a policy associated with the control area location; and the mobile device further configured to apply the policy to the mobile device.

Another aspect of the present invention provides computer program product for managing a mobile device in a mobile device management system (MDMS), the computer program product comprising a computer readable storage medium, and program instructions stored on the computer readable storage medium, to: receive control area access information, wherein the control area access information is associated with an entry or exit of a control area location by a mobile device user; determine a policy associated with the control area location; and apply the policy to the mobile device.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a representation of a network diagram of an example access control system according to illustrative embodiments.

FIG. 2 shows a first representation of an example location-based mobile device management system (MDMS) implementation according to illustrative embodiments.

FIG. 3 shows a second representation of an example location-based mobile device management system (MDMS) implementation according to illustrative embodiments.

FIG. 4 shows an example location-based control server entry/exit event process according to illustrative embodiments.

FIG. 5 shows an example location-based mobile device management system (MDMS) process according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments will now be described more fully herein with reference to the accompanying drawings, in which exemplary embodiments are shown. Embodiments described herein provide approaches relating generally to location position management of a mobile device and, more particularly, to a policy-based mobile device management system (MDMS) for determining a location of a mobile device based on the user's access history information and controlling the mobile device based on the location.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

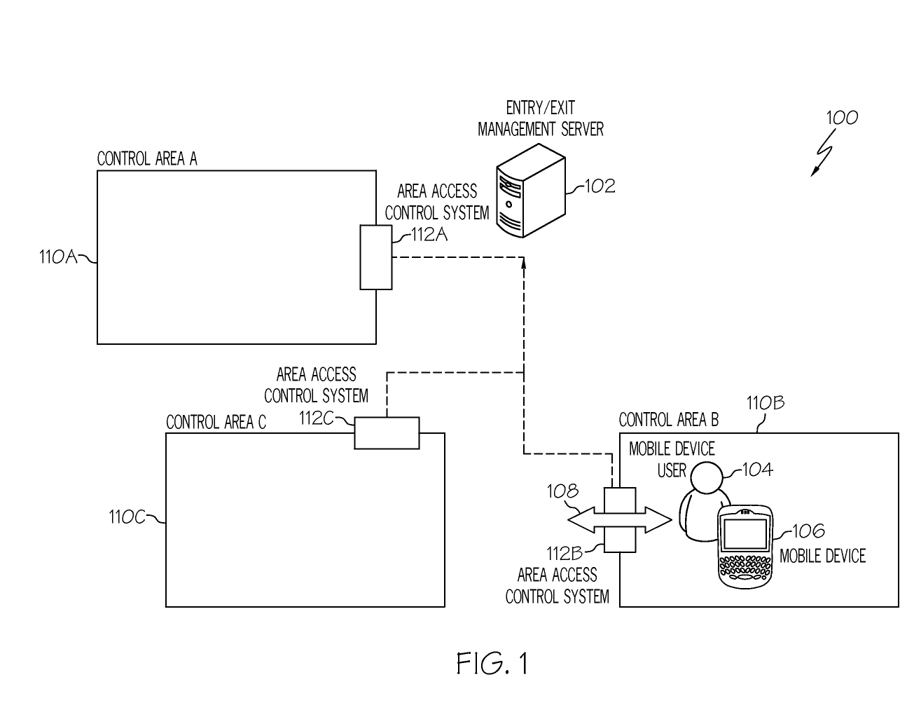

Referring now to FIG. 1, a representation of a network diagram of an example access control system 100 according to illustrative embodiments is shown. As shown, the access control system 100 includes an entry/exit management server 102, three control areas 110A-C, and a mobile device 106.

The access control system 100 is a policy-based access control management system which determines a location of a mobile device based on the user's access history information and controls the mobile device based on the location. The entry/exit management server 102 provides the management functions necessary for the operation of the access control system 100. The entry/exit management server 102 may be used to communicate with any number of area access control systems over a wireless network or a wire. The entry/exit management server 102 may include a server database (not shown) for storing data and/or applications.

The mobile device 106 is preferably a wireless communication device (e.g., a cell phone, smart phone, wireless-enabled PDA, laptop computer, etc.) that is configured to communicate with area access control systems 112A-C over a wireless network. The mobile device 106 may include a mobile device database (not shown) for storing data for software applications executed by the mobile device 106, such as an electronic messaging application, a document processing application, a calendar application, an address book application, a web browser application, and/or other software applications.

Copies of the data stored in the mobile device database, along with additional related data, may also be stored in the server database associated with the entry/exit management server 102. For example, policy data (discussed below) or other data may be stored in the server database and then forwarded to the mobile device 106. Alternatively, the data in the mobile device database may be synchronized with the data in the server database using known database synchronization techniques.

Three separate wireless areas are shown: control area A 110A, control area B 110B, and control area C 110C. A boundary for each respective area is illustrated. Each area may include an area access control system. For example, control area A 110A includes area access control system 112A. Control area B 110B includes area access control system 112B. Control area C 110C includes area access control system 112C. Each area access control system 112A-C records the entry/exit 108 of each person to/from the respective control area. The entry and exit data is transmitted to the entry/exit management server 102. Each area access control system 112A-C may be used to communicate with any number of mobile devices (e.g., such as mobile device 106) over a wireless network

In general, a user always carries a mobile device, so the user's location is the same as the location of the mobile device. An area access control system 112A-C may record each entry and exit by personnel into a control area using an identification (ID) card or radio frequency (RF) card access. Movement history is tracked by transmitting the entry/exit data to the entry/exit management server 102. The location-based mobile device management system (MDMS) leverages the personnel access control system which uses the user's access history information to determine the location of mobile handsets without the use of mobile devices to help identify the exact location. Each mobile device may be controlled by the MDMS. The MDMS manages the devices based on a policy set-up. The MDMS operates automatically without client involvement. Depending on the location of a respective mobile device, proper management and security requirements are applied automatically by the mobile device to ensure the mobile device remains secure.

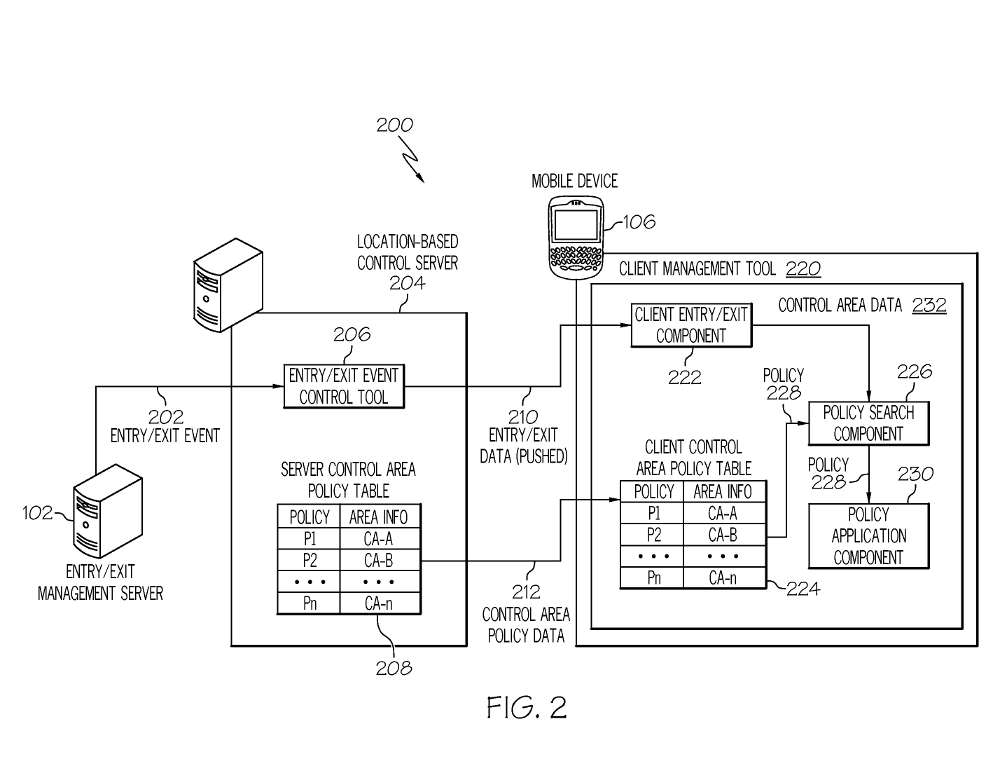

Referring now to FIG. 2, a first representation of an example location-based mobile device management system (MDMS) implementation 200 is shown. Implementation 200 is intended to represent a first type of MDMS system that may be implemented in deploying/realizing the teachings recited herein. FIG. 2 depicts entry/exit management server 102 and mobile device 106, similar to FIG. 1. Mobile device 106 includes client management tool 220 having a client entry/exit component 222, client control area policy table 224, policy search component 226 and policy application component 230.

Also depicted is location-based control server 204. The location-based control server 204 may provide mobile device management (MDM) software capable of providing an information technology (IT) department of a business or enterprise the ability to securely enroll mobile devices in an enterprise environment, wirelessly configure and update settings, monitor compliance with corporate policies, and remotely wipe or lock managed devices. The location-based control server 204 is configured to communicate with entry/exit management server 102 and mobile client 106. The location-based control server 204 includes entry/exit event control tool 206 and server control area policy table 208.

Location-based control server 204 includes server control area policy table 208. Server control area policy data 208 may be used to populate and/or update client control area policy table 224. In one example, server control area policy data 208 is pre-loaded onto the mobile device 106. In addition, client control area policy table 224 may be periodically updated via server control area policy data 208 when one or more changes are made to server control area policy table 208. As shown, server control area policy data 208 and client control area policy table 224 contain two columns of data: policy data (e.g., “P1” represents policy 1, “P2” represents policy 2, etc.) and control area location (e.g., “CA-A” represents control area A, “CA-B” represents control area B, etc.). Each control area location corresponds to a predefined control area, as shown in FIG. 1. A control area location is used to retrieve related policy data associated with a particular control area. The number of rows may equal the total number of predefined control areas. For example, FIG. 1 depicts three control areas (i.e., control areas A, B, and C). Therefore, server control area policy data 208 will contain three rows of policy data. A given policy, when applied to a mobile device 106, may determine the access capabilities and/or access restrictions of the mobile device 106 while the mobile device is within the respective control area. In one example, a default policy may be applied to the mobile device 106 upon exiting a defined control area.

In operation, entry/exit management server 102 receives entry/exit data from the access control system 100. For example, consider the example of a mobile device user 104 carrying a mobile device 106 (e.g., smart phone) entering control area B 110B. Each mobile device to be managed by the MDMS is first associated with a mobile device user. Entry into control area B 110B is recorded by area access control system 112B and transmitted to entry/exit management server 102. Any new entry or exit data received at the entry/exit management server 102 triggers an entry/exit event 202. The entry/exit event control tool 206 of the location-based control server 204 is notified of the entry/exit event 202. The entry/exit event control tool 206 transmits entry/exit event data 210 associated with the entry/exit event 202 to the mobile device 106. Entry/exit data 210 may include, among other things, the identity of the person entering or exiting the control area, the control area location (e.g., control area B 110B), and a timestamp marking the time of the entry or exit.

Entry/exit data 210 is received by the client entry/exit component 222 of the client management tool 220. In other words, the entry/exit data 210 is “pushed” from the location-based control server 204. From the entry/exit data 210, the client entry/exit component 222 generates control area data 232. Control area data 232 may comprise and/or be based upon entry/exit data 210 (e.g., transformation). At the least, control area data 232 includes the identification of the control area associated with the entry or exit. Control area data 232 is transmitted to policy search component 226. The policy search component 226 searches the client control area policy table 224 for a match using the control area location received in the entry/exit data 210. The search may be performed by performing a table lookup operation based on the control area location. If a match of the control area location is found, the policy 228 associated with the control area location is transmitted to the policy application component 230. The policy application component 230 applies the policy 228 to the mobile device 106. For example, if mobile device user 104 enters control area B 110B, then policy “P2” will be applied to the mobile device 106. In one example, a default policy may be applied when a match is not found in the client control area policy table 224. The policy data allows for managing or controlling the mobile device 106. For example, the policy data may be operable to: securely enroll the mobile device 106 in an enterprise environment, limit access of the mobile device 106, wirelessly configure and update settings, monitor compliance with corporate policies, remotely wipe or lock the mobile device 106, or any other appropriate management or security function.

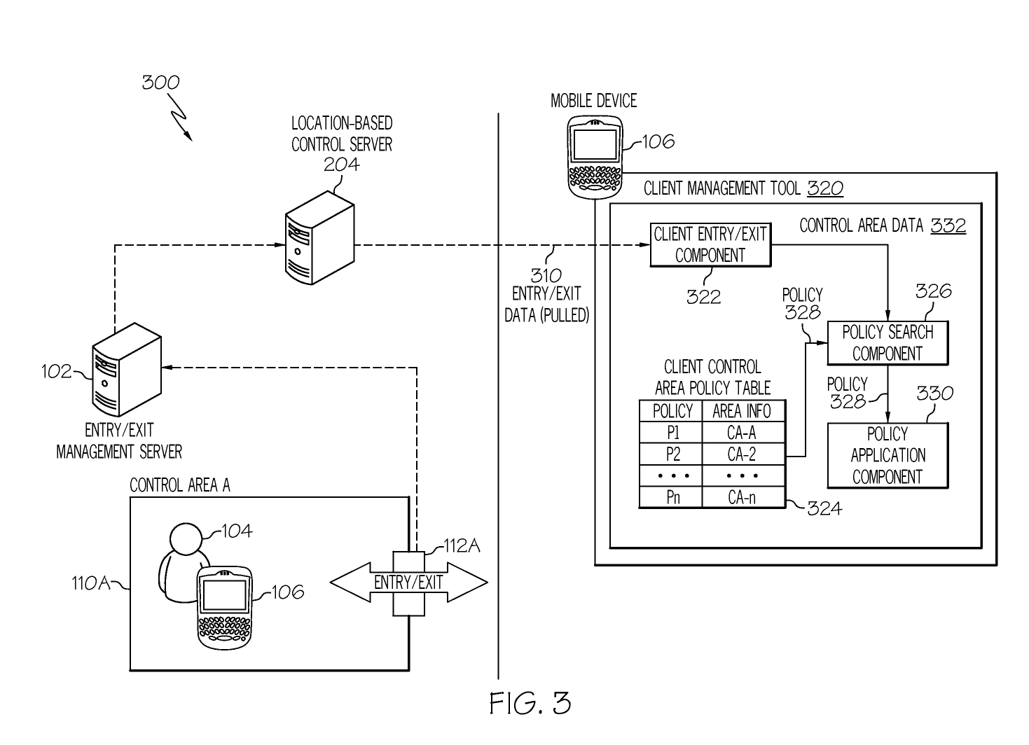

Referring now to FIG. 3, a representation of a second example location-based mobile device management system (MDMS) implementation 300 according to illustrative embodiments is shown. Implementation 300 is intended to represent a second type of MDMS system that may be implemented in deploying/realizing the teachings recited herein. FIG. 3 depicts entry/exit management server 102, location-based control server 204, and mobile device 106, similar to FIG. 2.

Unlike the entry/exit data 210 of FIG. 2 that is “pushed” from the location-based control server 204, the entry/exit data 310 of FIG. 3 is “pulled” by the client entry/exit component 322 of the mobile device 106 from the location-based control server 204 periodically. A client pull is a style of network communication where the initial request for data originates from the client, and then is responded to by the server. The reverse is known as push technology, where the server “pushes” or transmits data to clients. In one example, the approximate time between pulls may be set within each mobile device 106. In other examples, the approximate time between pulls may be determined by other means.

In operation, entry/exit management server 102 receives entry/exit data from the access control system 100. As shown in FIG. 3, consider the example of a mobile device user 104 carrying mobile device 106 (e.g., smart phone) entering control area A 110A. Entry into control area A 110A is recorded by area access control system 112A and transmitted to entry/exit management server 102. Any new entry or exit data received at the entry/exit management server 102 is passed on to the location-based control server 204. Entry/exit data 210 may include, among other things, the identity of the person entering or exiting the control area, the control area location (e.g., control area A 110A), and a timestamp marking the time of the entry or exit.

Periodically, the client entry/exit component 322 of the client management tool 220 polls the location-based control server 204 for new entry/exit data 310. When found, the entry/exit data 310 is pulled (i.e., retrieved) from the location-based control server 204 to the mobile device 106. Similar to FIG. 2, the client entry/exit component 322 generates control area data 332 from the entry/exit data 310. Control area data 332 may comprise and/or be based upon entry/exit data 310 (e.g., transformation). At the least, control area data 332 includes the identification of the control area associated with the entry or exit. Based on the example depicted in FIG. 3, the control area data 332 includes data associated with control area A 110A. The control area data 332 (i.e., an identifier associated with control area A) is transmitted to policy search component 326. The identifier may be a number, character, symbol, character string, or any combination thereof. The policy search component 326 searches the client control area policy table 324 for a match to control area A identifier. The policy 328 (“P1”) associated with control area A is found. The policy “P1” is transmitted to the policy application component 330. The policy application component 330 applies policy “P1” to the mobile device 106.

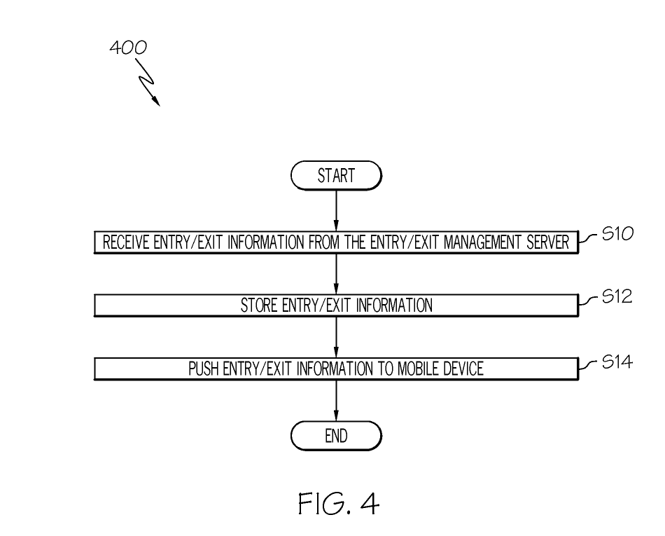

FIG. 4 shows an example location-based control server entry/exit event process according to illustrative embodiments. At S10, entry/exit information is received at the location-based control server from the entry/exit management server. At S12, the entry/exit information is stored at the location-based control server. At S14, the entry/exit information is transmitted to the mobile device associated with the entry/exit information.

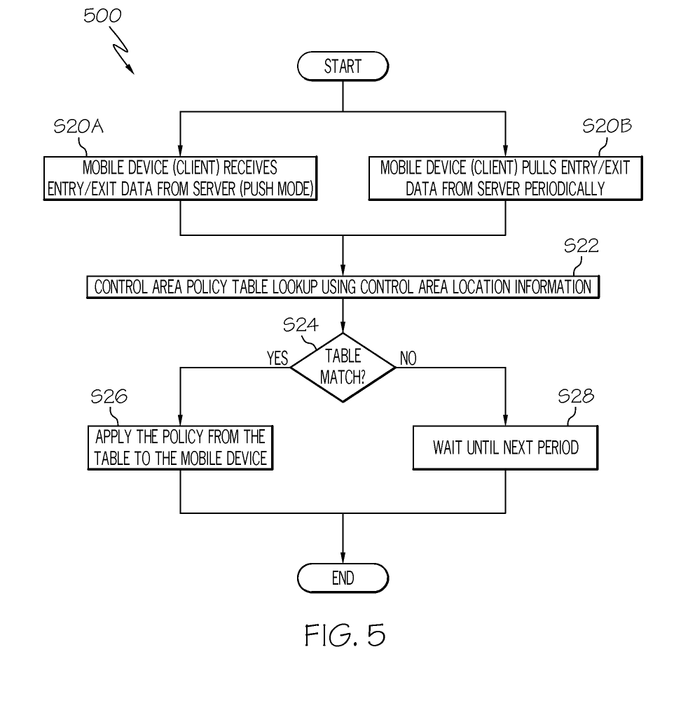

FIG. 5 shows an example location-based mobile device management system (MDMS) process according to illustrative embodiments. In one example, at S20A, the mobile device (client) receives entry/exit data from a server. In a second example, at S20B, the mobile device pulls entry/exit data from the server periodically. At S22, a control area policy table lookup is performed using control area location information. The control area location information is included in, or derived from, the entry/exit data. At S24, a determination is made whether an entry in the control area policy table matches the control area location information. If a match is found, the policy retrieved from the control area policy table is applied to the mobile device at S26. If no match is found and the mobile device polls the server periodically for entry/exit data, the mobile device waits for the period of time until the server is polled again at S28.

It should be noted that, in some alternative implementations, the functions noted in the blocks may occur out of the order noted in FIGS. 4 and 5. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as a MDMS solution, it is understood that the invention further provides various alternative embodiments. For example, in one embodiment, the invention provides a computer-readable/useable medium that includes computer program code to enable a computer infrastructure to provide financial transaction record generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a computer-implemented method for applying policy data to a mobile device. In this case, a wireless infrastructure, such as implementation 100 (FIG. 1), can be provided and one or more systems for performing the processes of the invention can be obtained (e.g., created, purchased, used, modified, etc.) and deployed to the wireless infrastructure. To this extent, the deployment of a system can comprise one or more of: (1) installing program code on a mobile device, from a computer-readable medium; (2) adding one or more computing devices to the wireless infrastructure; and (3) incorporating and/or modifying one or more existing systems of the wireless infrastructure to enable the wireless infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A computer-implemented method for managing a mobile device in a mobile device management system (MDMS), comprising:
receiving control area access information resulting from a mobile device user using a control area entry card that is separate from the mobile device, wherein the control area access information is associated with an entry or exit of a control area location by the mobile device user;
determining, in response to the receiving, a policy associated with the control area location; and
applying the policy to the mobile device.

2. The method of claim 1, wherein the control area access information is pulled by the mobile device from a server.

3. The method of claim 1, wherein the control area access information is pushed to the mobile device from a server.

4. The method of claim 1, wherein the control area location is managed by an access control system configured to record each entry and exit into the control area location.

5. The method of claim 1, wherein the policy defines an access restriction.

6. The method of claim 1, wherein the step of determining the policy comprises performing a table lookup of a client control area policy table based on a control area identifier, wherein the control area identifier is associated with the control area location.

7. The method of claim 6, wherein the client control area policy table is updated from a server control area policy table.

8. A mobile device management system for managing a mobile device, comprising:
a mobile device configured to communicate with a server;
the server configured to store control area access information resulting from a mobile device user using a control area entry card that is separate from the mobile device, wherein the control area access information is associated with an entry or exit of a control area location by the mobile device user;
the mobile device further configured to receive the control area access information from the server;
the mobile device further configured to determine, in response to receipt of the control area access information, a policy associated with the control area location; and
the mobile device further configured to apply the policy to the mobile device.

9. The mobile device management system of claim 8, wherein the control area access information is pulled by the mobile device from the server.

10. The mobile device management system of claim 8, wherein the control area access information is pushed to the mobile device from a server.

11. The mobile device management system of claim 8, wherein the control area location is managed by an access control system configured to record each entry and exit into the control area location.

12. The mobile device management system of claim 8, wherein the policy defines an access restriction.

13. The mobile device management system of claim 8, wherein the step of determining the policy comprises performing a table lookup of a client control area policy table based on a control area identifier, wherein the control area identifier is associated with the control area location.

14. The mobile device management system of claim 13, wherein the client control area policy table is updated from a server control area policy table.

15. A computer program product for managing a mobile device in a mobile device management system (MDMS), the computer program product comprising a computer readable storage device, and program instructions stored on the computer readable storage device, to:
receive control area access information resulting from a mobile device user using a control area entry card that is separate from the mobile device, wherein the control area access information is associated with an entry or exit of a control area location by the mobile device user;
determine, in response to receipt of the control area access information, a policy associated with the control area location; and
apply the policy to the mobile device.

16. The computer-readable storage medium according to claim 15, wherein the control area access information is pulled by the mobile device from a server.

17. The computer-readable storage medium according to claim 15, wherein the control area access information is pushed to the mobile device from a server.

18. The computer-readable storage medium according to claim 15, wherein the control area location is managed by an access control system configured to record each entry and exit into the control area location.

19. The computer-readable storage medium according to claim 15, wherein the policy defines an access restriction.

20. The computer-readable storage medium according to claim 15, the computer readable storage medium further comprising instructions to perform a table lookup of a client control area policy table based on a control area identifier to determine the policy, wherein the control area identifier is associated with the control area location.
